(19) United States
(12) Patent Application Publication
(10) Pub. No.: US 2022/0019958 A1
(43) Pub. Date: Jan. 20, 2022

(54) MULTIFACETED PROJECT MANAGEMENT RESOURCE SCHEDULING

(71) Applicant: Salesforce.com, Inc., San Francisco, CA (US)

(72) Inventors: Michael MCGEEHAN, III, New York, NY (US); Vlad MAZA, New York, NY (US); Andrew PAQUIN, San Francisco, CA (US); Joon LEE, San Francisco, CA (US)

(73) Assignee: Salesforce.com, Inc., San Francisco, CA (US)

(21) Appl. No.: 16/929,713

(22) Filed: Jul. 15, 2020

(51) Int. Cl. G06Q 10/06; G06K 9/62; H04L 29/06

(52) U.S. Cl. CPC G06Q 10/063112; G06Q 10/063118; G06Q 10/06313; H04L 67/40; G06K 9/6215

(57) ABSTRACT

DESCRIBED HEREIN ARE SYSTEMS, APPARATUS, METHODS AND COMPUTER PROGRAM PRODUCTS CONFIGURED FOR DETERMINATION OF RECOMMENDED PROJECT TEAMS BASED ON IMPERFECT INFORMATION. IN CERTAIN EMBODIMENTS, A DISTANCE FUNCTION MAY BE UTILIZED TO DETERMINE THE RECOMMENDED PROJECT TEAM AND/OR DETERMINE ACTIONS TO BE TAKEN TO IMPROVE A POTENTIAL PROJECT TEAM. THUS, FOR EXAMPLE, PROJECT TEAM MEMBERS MAY BE RECOMMENDED FOR UPSKILLING BEFORE THE PROJECT KICKS OFF. UPSKILLING OF CERTAIN MEMBERS MAY ALLOW FOR OPTIMIZATION OF THE PROJECT TEAM. ADDITIONAL OPTIMIZATION MAY ALSO BE RECOMMENDED AND/OR PERFORMED, AS DESCRIBED HEREIN.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever

### FIELD OF TECHNOLOGY

This patent document relates generally to database systems and more specifically to database systems and techniques for project management.

### BACKGROUND

Many projects require a mix of human resources, physical resources, geographic location and availability. Projects are often made up of a team of a plurality of team members. Though project management programs are available, they typically only allow schedule and resource planning when there is perfect information.

However, assembling the optimal project team is typically a manual process. Additionally, many situations allow for only imperfect information. As such, resources may be easily misallocated.

### BRIEF DESCRIPTION OF THE DRAWINGS

The included drawings are for illustrative purposes and serve only to provide examples of possible structures and operations for the disclosed inventive systems, apparatus, methods and computer program products for project management resource scheduling. These drawings in no way limit any changes in form and detail that may be made by one skilled in the art without departing from the spirit and scope of the disclosed implementations.

FIG. 1 illustrates an example overview method for project management database resource planning, performed in accordance with one or more embodiments.

FIG. 2 illustrates another example method for project management database resource planning, performed in accordance with one or more embodiments.

FIG. 3 illustrates an example method for project management database resource upskilling, performed in accordance with one or more embodiments.

FIG. 4 illustrates another example method for project management database resource upskilling, performed in accordance with one or more embodiments.

FIG. 5 illustrates an example project management system, in accordance with one or more embodiments.

FIGS. 6-11 illustrate examples of graphical user interfaces configured in accordance with one or more embodiments.

FIG. 12 illustrates an example configuration of a neural network, configured in accordance with one or more embodiments.

FIG. 13 shows a block diagram of an example of an environment that includes an on-demand database service, configured in accordance with some implementations.

FIGS. 14A and 14B illustrate examples of a computing system, configured in accordance with one or more embodiments.

FIG. 15 illustrates an example of a computing device, configured in accordance with one or more embodiments.

### DETAILED DESCRIPTION

Some implementations of the disclosed systems, apparatus, methods and computer program products are configured for project management resource scheduling. A system may determine project management parameters, provide project ratings for potential project team members associated with the project management parameters, and determine a team composition based on the project ratings and/or determine an upskilling action for one or more of the project team members.

Specifically, the disclosed systems and techniques allow for determination of recommended project teams based on imperfect information. In certain embodiments, a distance function may be utilized to determine the recommended project team.

Additionally, the disclosed systems and techniques allow for determination of actions to be taken to improve the project team. Thus, for example, project team members may be recommended for upskilling before the project kicks off. Upskilling of certain members may allow for optimization of the project team. Additional optimization may also be recommended and/or performed, as described herein.

In a first example, Jackie is a project manager at A-Hoodies, a source of fine unique hoodies. Jackie is trying to put together a project team for her new hoodie design. A-Hoodies' designers run the gamut of experience levels and creativity skills and all work remotely. However, for this project, Jackie requires a team that is able to meet at A-Hoodies headquarters to review the hoodie prototypes, as Jackie expects to have a detailed fine tuning process to ensure the best fit. Furthermore, Jackie's project requires a mix of design creativity, production knowledge, and logistical pipeline skills. If the team were to lack any one of these skills, the chances of the project succeeding are greatly reduced. As such, Jackie utilizes the multifaceted project management tool “SaleManage” to aid in planning her project.

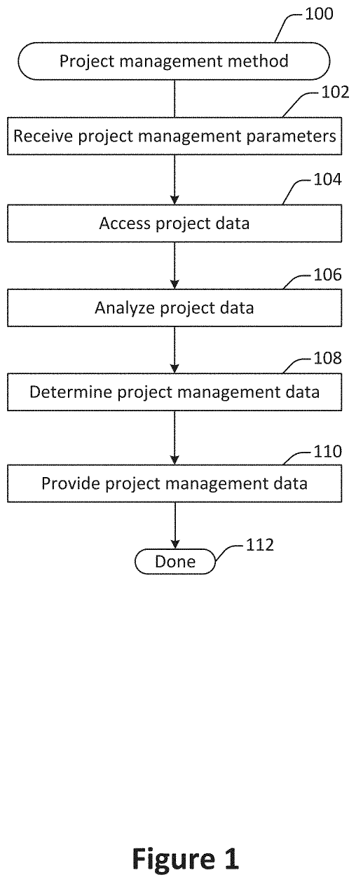

FIG. 1 illustrates an example overview method 100 for project management database resource planning, performed in accordance with one or more embodiments. Project team optimization may be determined through the use of distance functions, similar to techniques utilized in, for example, mapping software. The method 100 may be used to optimize project team groups and to coordinate any needed actions to aid in further optimization. As such, the techniques described herein allow for the composition of a project team to be adjusted by changing the characteristics of the members themselves, through upskilling, movement of project team headquarters, or through other actions.

Project management parameters are received in 102. The project management parameters may be received by a server device for a database and/or received from another electronic device associated with the project manager. Thus, for example, the project manager may manually enter project team member characteristics desired (e.g., characteristics present within each individual member or present within the team as a whole), the goal of a project, the timeline of a project, the budget of a project, and/or other such characteristics. The project management parameters may include, for example, skillset requirements, availability requirements, distance requirements, and other such requirements.

Thus, for example, Jackie enters the characteristics and geographical requirements that she desires for project team members on her electronic device through the SaleManage application. Furthermore, Jackie specifies whether these characteristics are critical, optional but preferred, or another category. The characteristics include baseline levels of design creativity, production knowledge, and logistical pipeline skills that are required for her project. She specifies that each member should have the baseline level of design creativity, but that the project team only requires one member with the baseline production knowledge and logistical pipeline skill. Furthermore, she specifies that it would be preferred to have project team members that are close to A-Hoodie's headquarters in Birmingham, England.

Project data is accessed in 104. The project data may include ratings associated with various skillsets of one, some, or all of the potential project team members. Thus, in Jackie's example, the ratings may include skill rates associated with one or more skills of potential project team members or a database of potential team members. There may be ratings for each of design creativity, production knowledge, and/or logistical pipeline skills. Additionally, ratings may be directed to other aspects of the characteristics of the potential project team members, such as the geographical location of the potential team members, the willingness to travel of each of the potential team members, and/or other such characteristics. The project data may be, for example, stored in a project database of a database system.

In 106, the project data may be analyzed. Analysis of the project data may result in, for example, determining an optimal composition of a project team utilizing a distance function, determining one or more upskilling actions for one or more potential project team members, determining one or more alternative compositions of a project team (e.g., for contingencies purposes and/or determining other actions based on the project data. As the project data may, in certain examples, include a plurality of factors, analysis of the project data may include weighting one or more of the factors of the project data.

Thus, for example, project data accessed by A-Hoodie through the SaleManage application may include skill ratings for each potential member in the categories of design creativity, production knowledge, and/or logistical pipeline skills. Additionally, SaleManage may determine a geographical rating for each of the team members based on the geographical location of the member relative to Birmingham. Furthermore, the willingness to travel of each team member may be rated (e.g., based on survey results conducted with the member) and the upskilling potential of each team member may be determined based on the speed and efficiency that the team member had previously displayed in upskilling actions. The availability of the potential team members (e.g., the amount of hours that they will be available to work for each week) may also be rated. Additionally, the compensation level of the team member may also be determined based on the project data.

In 108, project management data may be determined. In various embodiments, project management data may include one or more of 1) ratings for some or all of the potential team members (e.g., an overall rating and/or ratings for certain aspects of potential team members), 2) a recommended project team composition, 3) one or more upskilling actions for at least one of the potential team members, 4) an upskilling source associated with the upskilling action, and/or 5) a selected project team. In certain embodiments, a project team may be automatically selected based on, for example, a composition of a project team that provides the highest suitability rating, determined as described herein. Project management data may also include other data useful for forming a project team.

Project management data may be determined based on the analysis of the project data (e.g., via one or more processors of the server device). For example, in certain embodiments, a distance function may be utilized to determine the composition of a project team. As such, for example, the various requirements of the project team may be mapped as nodes. The skills and characteristics of the potential team members may then be applied to determine the optimal composition of the team members. In certain embodiments, different weighting may be applied in the distance function based on the importance of each of the factors, whether the factors are required or optional, whether the requirement is a minimum (e.g., minimum number of people needed for a certain skillset), maximum (e.g., maximum budget), or other type of requirement, and/or other considerations. Such weighting may be topology within the distance function. Based on the distance function, a recommended composition of the project team may be determined.

Additionally, the determined project management data may include one or more upskilling actions for the potential team members. That is, in certain examples, it may be determined that a recommended project team may be formed if one or more team members is upskilled. Such a situation may be due to none of the potential team members including all of the required skills, because upskilling one or more potential team members better optimizes the team member composition (e.g., lowers the cost of the team), because the restrictions imposed (e.g., maximum number of team members) do not allow for a recommended project team to be formed without upskilling, or due to another such condition. The upskilling action determined may include, for example, one or more potential team members learning a new skill, learning a new language, earning a badge to be certified to be proficient in a category, or another upskilling action.

In the example of Jackie, SaleManage determines that the optimal project team includes the members Hernan, Stacey, and Ruth. However, none of the three potential team members includes the necessary logistical pipeline skill. As only one team member is required to possess the skill, SaleManage's application recommends Hernan for upskilling to obtain the necessary logistical pipeline skill as Hernan is the only potential team member of the three that has previously been tested to be proficient in baseline logistics.

The project management data may also include additional recommendations. For example, based on the location of the potential project team members and requirement that there be in-person meetings, SaleManage may provide a recommended location for where an in-person meeting is optimal (e.g., a location that minimizes the total travel costs for the team) and/or provide a recommended travel budget for the project team. In certain embodiments, recommended bookings for one or more of the potential project team members may also be provided.

The project management data may be communicated to, for example, an electronic device in 110. Thus, the server device may transmit the project management data to the electronic device over one or more networks (e.g., the Internet, a local area network, 3G, 4G, 5G, and/or other wired and/or wireless data connections). Thus, SaleManage's server may transmit the project management data to Jackie's electronic device via the one or more data connections. After receiving the project management data, Jackie's electronic device may display the project management data in a manner described herein. Thus, for example, one or more recommended project teams may be suggested, an upskilling action may be suggested, an additional option may be suggested, the electronic device may provide one or more options for selection, and/or additional data may be provided, as described herein. In various embodiments, the electronic device may provide the data in the form of visual, audio, haptic, and/or other type of communications. The technique may then finish in 112.

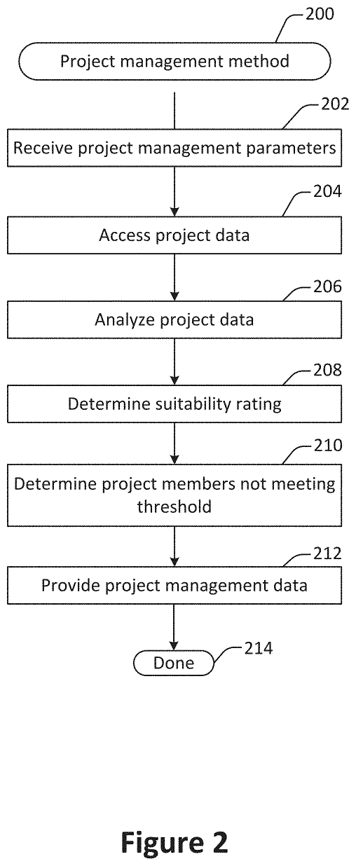

FIG. 2 illustrates another example method for project management database resource planning, performed in accordance with one or more embodiments. FIG. 2 illustrates project management technique 200. Project management technique 200 further details the determination of recommended project teams.

Project management parameters are received in 202, project data is accessed in 204, and project data is analyzed in 206, 202, 204, and 206 of FIG. 2 may be similar to 102, 104, and 106 of FIG. 1, respectively. In 208, a suitability rating may be determined for each of the potential project team members. The suitability rating may be based on the project management data and the project management parameters. As such, for example, the suitability rating may be based on an analysis of the project management data in accordance with the desired characteristics.

Thus, for example, SaleManage may determine suitability ratings for each of Hernan, Stacey, and Ruth based on Jackie's requirements that each member include a baseline level of design creativity, that at least one member has a baseline level of production knowledge, that at least that or another member has a baseline level of logistical pipeline skill, and that the project team members that are close to Birmingham are preferred. The suitability rating may be determined via a distance function as described herein. In various embodiments, the suitability rating may be a single rating or may be a plurality of ratings, each rating associated with one or more categories. In various embodiments, condition suitability ratings may be provided. Thus, for example, Stacey and Ruth may each be provided a suitability rating based on if Hernan is selected for upskilling and may additionally include another rating if Hernan is not selected for upskilling and, thus, another team member would need to be upskilled.

A threshold suitability rating may be specified (e.g., by default or by a user). In 210, the suitability rating is compared to the threshold rating and potential project team members with suitability ratings not meeting the threshold rating may be determined. The suitability rating may be a single rating, in which case potential team members not meeting the threshold suitability rating may be eliminated from consideration. However, other embodiments may include a plurality of ratings. In such embodiments, certain ratings may be ratings where, if the threshold rating is not met, the potential project team member may be eliminated from consideration, but other ratings may not disqualify the potential project team member from project team consideration.

As such, in the example of A-Hoodie, two suitability ratings for Hernan, Stacey, and Ruth are determined. A first suitability rating may be based on the design creativity rating of each of the potential team members while a second suitability rating may be based on the other factors. Potential team members whose first suitability rating does not meet the threshold for the first suitability rating are eliminated. Stacey's first suitability rating does not meet the threshold, while Hernan and Ruth's first suitability ratings do meeting the threshold. The second suitability rating is then used to rank the remaining potential team members.

After determining the potential team members that meet the threshold, the project management data associated with the remaining eligible team members are then presented to the user. In 212, such project management data may be provided to an electronic device of the user. The technique of 212 may be similar to that of 110.

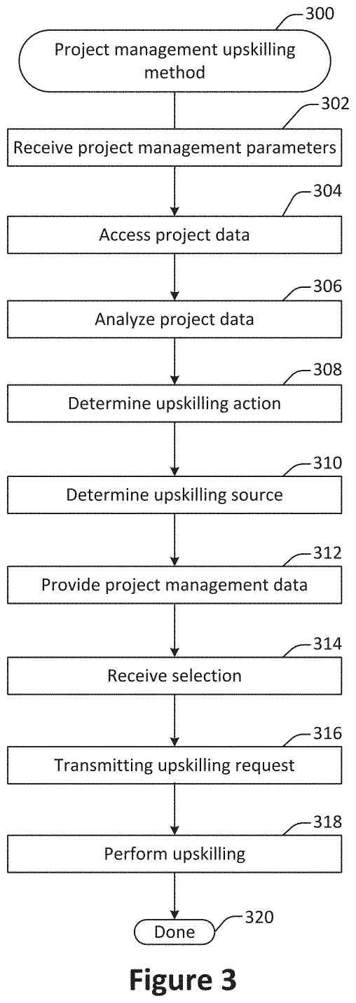

FIG. 3 illustrates an example method for project management database resource upskilling, performed in accordance with one or more embodiments. FIG. 3 illustrates project management upskilling technique 300 that provides for upskilling of one or more potential project team members. Project management parameters are received in 302, project data is accessed in 304, and project data is analyzed in 306, 302, 304, and 306 may be similar to 102, 104, and 106, respectively.

In 308, one or more upskilling actions may be determined. The upskilling action may be based on project management data determined from the analysis of 306. In certain embodiments, it may be determined that a recommended project team would benefit from the upskilling of one or more potential team members. The determination may be based on determining that none of the potential team members includes all of the required skills, because upskilling one or more potential team members better optimizes the team member composition, because certain the restrictions imposed do not allow for a recommended project team to be formed without upskilling, or due to another such condition. The upskilling action determined may include, for example, one or more potential team members learning a new skill, learning a new language, earning a badge to be certified to be proficient in a category, or another upskilling action. Thus, for example, SaleManage may determine that, for an optimized project team, Hernan should be upskilled obtain the necessary production knowledge and logistical pipeline skill.

In 310, based on the upskilling action, an upskilling source may be determined. The upskilling source may be determined through upskilling data from an upskilling database. The upskilling data may include data directed to one or more upskilling providers, Thus, for example, specific categories of upskilling may include associations with certain upskilling providers within the database (e.g., a category of the database may be structured to reference the upskilling providers and/or each upskilling provider within the database may reference the associated upskilling categories).

Information for accessing or engaging the upskilling providers may also be provided. Such information may include contact information, one or more website links, direct linking to the upskilling (e.g., a direct link may be provided for potential upskilling actions to, for example, provide an online class for the recipient of the upskilling), and/or other information directed to the upskilling (e.g., the description of the steps for upskilling). In certain embodiments, tests associated with the upskilling (e.g., tests to determine the baseline skill of an employee, aptitude tests to determine the result of upskilling, and/or other such tests) may also be associated with the upskilling within the database. Such tests may also be provided by the server device.

As such, for A-Hoodie, upon determining that Hernan will be upskilled to obtain the necessary production knowledge and logistical pipeline skill, SaleManage determines, from their database, that production training may be provided by Trainers R Us and logistical training may be provided by UpSkeel and also by A-Hoodie's internal training system. SaleManage also determines that a baseline skill test is available from Trainers R Us.

The information associated with the upskilling source may be provided as part of the project management data. Project management data may be provided in 312. Project management data may be provided in 312, similar to 110. In certain examples, the project management data may allow the user to confirm one or more upskilling actions and/or select one or more upskilling providers for the upskilling action. As such, for example, the project management data may allow Jackie to confirm the upskilling of Hernan and select the upskilling provider. Based on the project management data, Jackie confirms production and logistical training for Hernan and selects A-Hoodie's internal training for the logistical pipeline skill.

Such selections by the user are communicated to the server device and received by the server device in 314. Communication of such selections maybe through one or more communications mediums as described herein. Upon receiving the selections, an upskilling request may be created based on the selections and the upskilling request may be provided in 316. The upskilling request may include, for example, a selection of an upskilling vendor, a request to provide a skill test to a user, and/or another upskilling associated action. In certain embodiments, the upskilling request may be transmitted to an outside upskilling provider. In another embodiment, the upskilling request may be provided to a secondary API (e.g., an API associated with SaleManage). The secondary API may be, for example, an API associated with upskilling or testing.

Based on the upskilling request of 316, upskilling may be performed in 318. Upskilling performed in 318 may include, for example, providing lessons, testing, providing exercises, and/or other actions that allow for a potential team member to become proficient in one or more skills. As such, based on the upskilling request of 316, upskilling lessons may be provided to Hernan directly (e.g., via message or e-mail) or indirectly (e.g., provided to A-Hoodie who then administers the upskilling to Hernan).

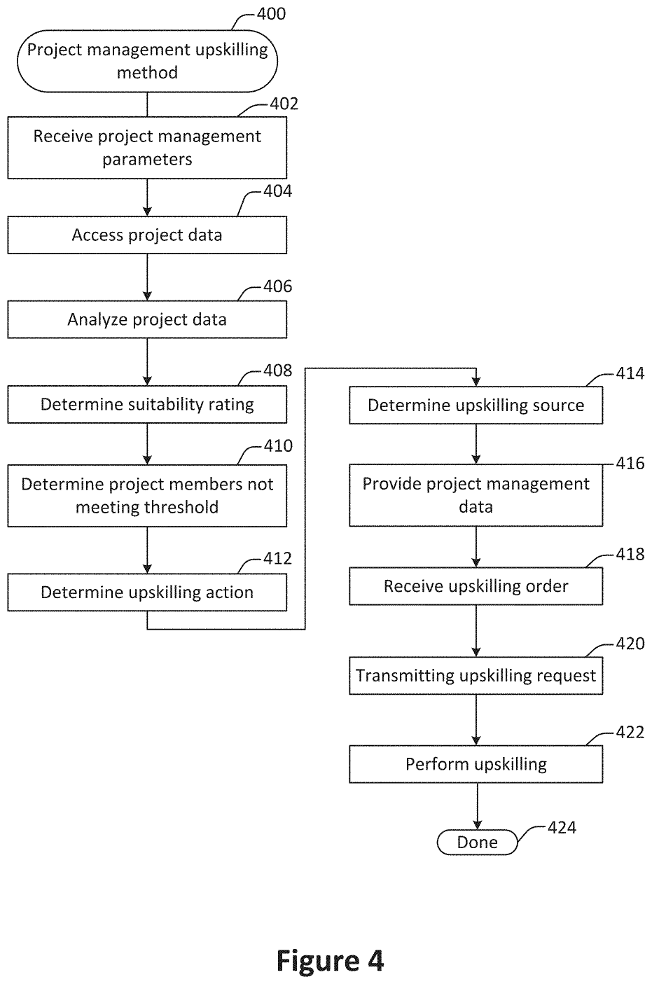

FIG. 4 illustrates another example method for project management database resource upskilling, performed in accordance with one or more embodiments, FIG. 4 illustrates project management upskilling technique 400. Project management parameters are received in 402, project data is accessed in 404, and project data is analyzed in 406. 402, 404, and 406 may be similar to 102, 104, and 106, respectively. Additionally, 408 and 410 may be similar to 208 and 210, respectively. 412, 414, and 416 may be similar to 308, 310, and 312, respectively.

In 418, an upskilling order is received from a user device. The upskilling order may be received through one or more communications mediums, as described herein. The upskilling order may be, for example, a selection of an upskilling vendor, a request to provide a skill test to a user, and/or another upskilling associated action. The upskilling order may identify the categories to be upskilled and/or the courses or curriculum for upskilling. In certain embodiments, threshold test scores in order to earn a certification or badge may also be specified. In various embodiments, the upskilling order may include a start by date, finish by date, a period for the upskilling to be performed within, and/or other such information. The upskilling order may identify the person to be upskilled and/or the contact information of the upskilling recipient. In various embodiments, the upskilling order may additionally include other information.

In 420, upon receipt of the upskilling order, an upskilling request is transmitted to an upskilling vendor and/or an associated API. The upskilling request may include the information associated with the upskilling order and may include additional information such as the identity of the organization requesting the upskilling. Based on the upskilling request, upskilling may then be performed in 422. Performing the upskilling may be similar to that of 318.

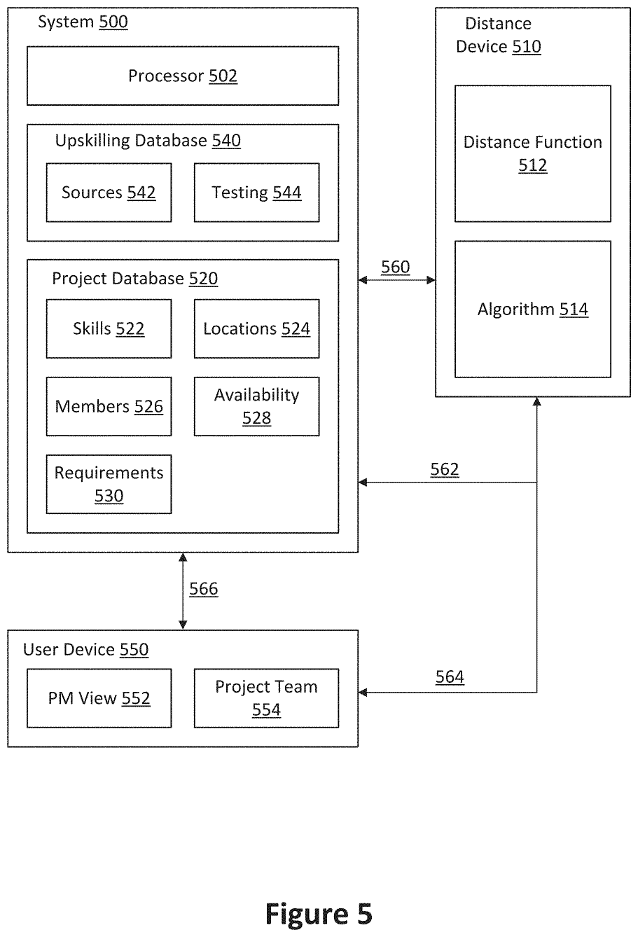

FIG. 5 illustrates an example project management system, in accordance with one or more embodiments. FIG. 5 illustrates a project management system that includes system 500, distance device 510, and user device 550.

System 500 includes processor 502, upskilling data 540, and project data 520. Processor 502 may be a processor for processing data (e.g., processing project data to determine one or more recommendations or actions). Processor 502 may include one or a plurality of processing cores and may additionally include transitory and/or non-transitory memory. Thus, for example, processor 502 may include one or more memories for storing instructions to perform the techniques described herein. System 500 may additionally include more components as described herein. Other portions of the system of FIG. 5, such as distance device 510 and user device 550, may additionally include processor, memories, and/or other components as described herein.

Upskilling database 540 may be a database structured to include data directed to upskilling. Upskilling database 540 may include upskilling sources 542 and upskilling testing 544. Upskilling sources 542 may be data indicating providers that may be used for upskilling various persons. In various embodiments, different upskilling providers may be associated with different categories of upskilling. Thus, upskilling database 540 may associate specific categories of upskilling with certain upskilling providers (e.g., a category of the database may be structured to reference the upskilling providers and/or each upskilling provider within the database may reference the associated upskilling categories).

Upskilling sources 542 may also include data associated with curriculums for upskilling (e.g., upskilling lessons, representations, and/or videos). In certain examples, the curriculums may be associated with a plurality of upskilling providers (e.g., a company may include standardized upskilling curriculums) or may be associated with a plurality of upskilling subjects (e.g., upskilling for different subjects may be performed according to a standardized schedule that is stored within upskilling database 540).

Upskilling testing 544 may include data associated with testing for upskilling. Such upskilling tests may determine a baseline level of skill of an upskilling recipient or determine whether a recipient of upskilling shows proficiency after upskilling. Thus, for example, after receiving upskilling, a recipient may be tested to determine whether the recipient is now proficient in the subject. If the recipient scores higher than a threshold score, the recipient may receive a certification or badge for the subject. The recipient's entry within project database 520 may then be accordingly updated to reflect the increased proficiency of the recipient.

Project database 520 includes data associated with one or more projects, project teams, potential team members, employment entities, and/or other data associated with project management. Variously, project database 520 includes skills 522, locations 524, members 526, availability 528, and requirements 530. One or more of skills 522, locations 524, members 526, availability 528, and requirements 530 may be stored in the same or separate databases within project database 520.

Skills 522 may include one or more skills associated with projects, such as skills needed in certain projects. Locations 524 may include data directed to locations of projects, project teams, potential team members, employment entities, and/or other entities. Members 526 may include data directed to potential project team members. Availability 528 may include data directed to the availability of one or more project team members (e.g., full time, part time, days when the potential team member is on vacation, etc.). Requirements 530 may include data directed to one or more requirements of one or more projects and/or project teams of project database 520.

In various embodiments, project database 520 may sort data by category, such as sorting based on one or more of skills 522, locations 524, members 526, availability 528, and requirements 530. Each project management category may be classified within one or more of skills 522, locations 524, members 526, availability 528, and requirements 530. Such a structure allows for efficient sorting of the requirements. Thus, the structure of project database 520 allows for optimized sorting of one or more requirements classified within skills 522, locations 524, members 526, availability 528, and requirements 530. Such a structure allows for a faster determination of the suitability of each project team member (e.g., by allowing for improved matching of project requirements to a potential project team members' skills) and also allows for improved determination of when upskilling or other changes to project team members may be required. For example, by associating project team members with other categories of skills, the likelihood of a potential project team possessing all required skills may be quickly determined from the available categories. The available categories may then allow for quick determination of the presence of the required skills within potential project team members.

Distance device 510 may be configured to receive project data and determine one or more recommended project teams and/or actions based on the project data. The project data may include project data as described herein, such as in FIGS. 1-4. Distance device 510 may include distance function 512 and algorithm 514. Distance function 512 may be a distance function to allow for optimization of project teams and project team recommendations. In various embodiments, project requirements and/or characteristics of potential project team members (e.g., their skillsets or skill ratings) may be defined as elements within distance function 512. Distance function 512 may further include topologies and other features used to determine a recommended project team. In various embodiments, the topology may include requirements and characteristics such as minimizing cost, minimizing travel times, the location of the various potential project team members, the cost of various potential project team members, and other such considerations.

Algorithm 514 may include one or more algorithms for determining a recommended project team, recommended upskilling actions, and/or other determinations described herein. In various embodiments, algorithm 514 may be utilized by the distance functions described herein. Algorithm 514 may define the weights and various factors of the distance functions described herein.

In certain embodiments, distance device 510 may be an electronic device (e.g., server device) or API separate from system 500. For example, in certain embodiments, distance device 510 may be a mapping API. System 500 may be associated with a project management API. To determine recommended project team compositions, the project management API may query the mapping API for the project team recommendations. The query may include the project team requirements, the characteristics of the potential project team members, the preferences of the project team requirements, and/or other such requirements and data within upskilling database 540 and project database 520. The data may be provided to the mapping API by the project management API. The mapping API may then provide the recommendations. In other embodiments, distance device 510 may be integrated with system 500 (e.g., may be stored within a database of system 500).

User device 550 may include PM view 552 and project team 554, Project team 554 may include data for a recommended project team and/or other recommendations determined based on the techniques described herein. PM view 552 may be information presented on a user interface of user device 550 and may include project team 554 and other data described herein.

Communications networks 560, 562, 564, and 566 are communications networks for communication of data between system 500, distance device 510, and user device 550. Communications networks 560, 562, 564, and 566 may be communications networks as described herein.

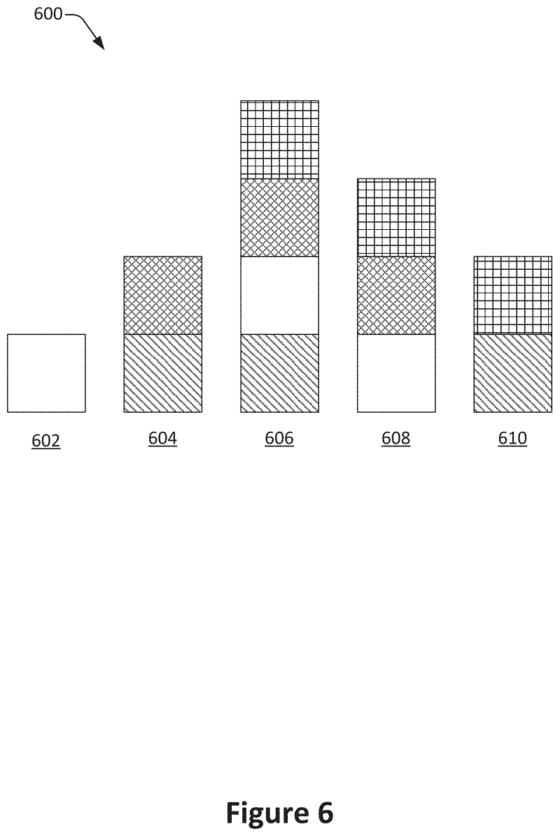

FIGS. 6-11 illustrate examples of graphical user interfaces configured in accordance with one or more embodiments. FIG. 6 illustrates an interface 600 that illustrates skill badges for potential project team members 602, 604, 606, 608, and 610. As shown in FIG. 6, the badges are shaded based on the subject of the badges, which may be directed to various subjects as described herein. Also, as shown in FIG. 6, the various project team members 602, 604, 606, 608, and 610 include a number of different badges,

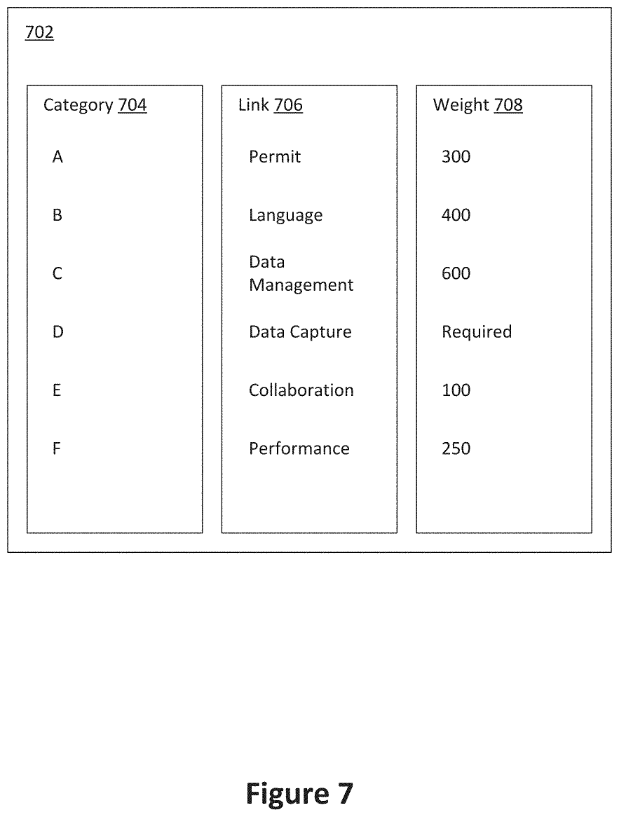

FIG. 7 illustrates an interface 700. Interface 700 includes category 704, link 706, and weight 708. Category 704 may include various project management categories. Such categories may include skillsets that are desired in a certain project. Link 706 may indicate the subject that each of the categories are linked with. The categories may be linked to one or more categories. Weight 708 may indicate the weight of each category, such as for use in a distance function. A higher weight may indicate a more important category for the project while a lower weight may indicate a less important category.

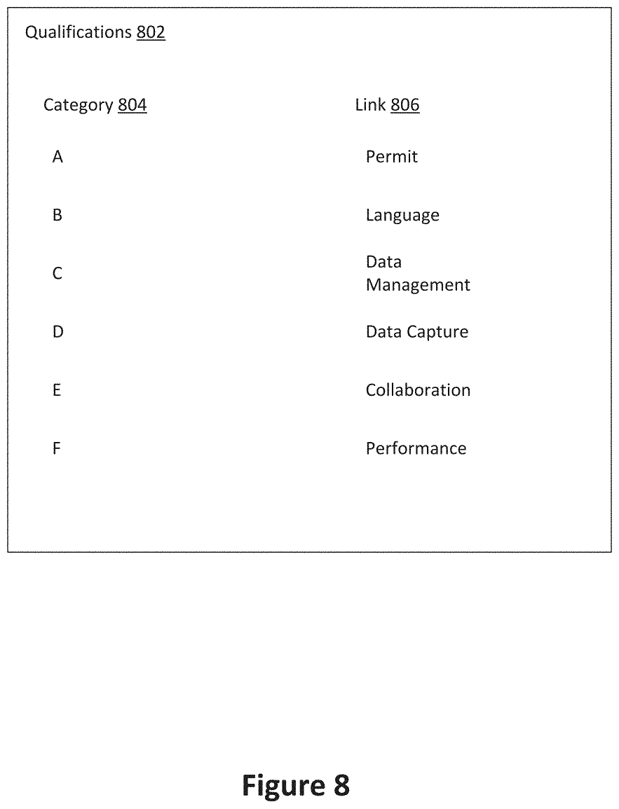

FIG. 8 illustrates qualifications 802. Qualifications 802 includes category 804 and link 806. Qualifications 802 may indicate the qualifications of a potential project team member. Category 804 may include skillsets of the potential project team member. Link 806 may indicate the subject that each of the categories are linked with.

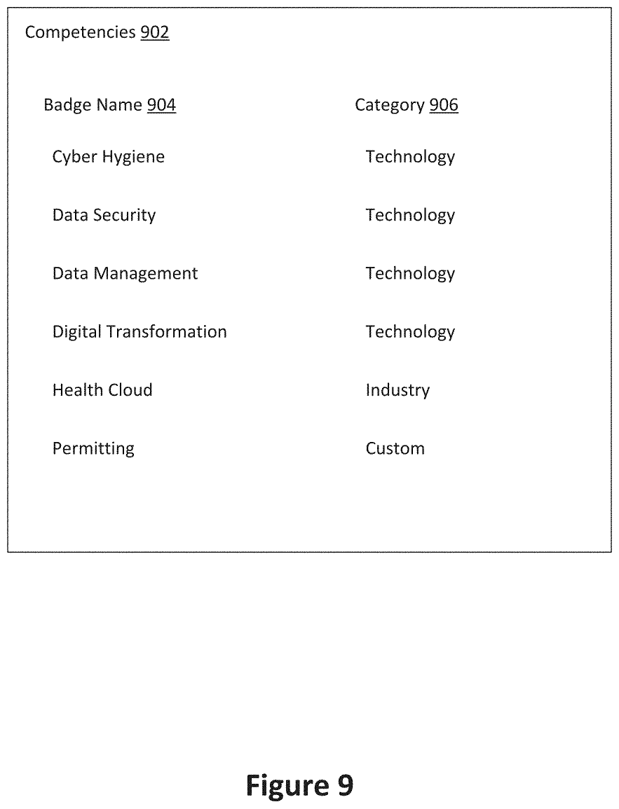

FIG. 9 illustrates competencies 902. Competencies 902 includes badge name 904 and category 906. Competencies 902 may indicate the badges that a potential project team member has accumulated. Such badges may indicate proficiencies in certain subjects. Badge name 904 may list such badges. Each of the badges may be associated with one or more upskilling categories. Such categories are listed in category 906.

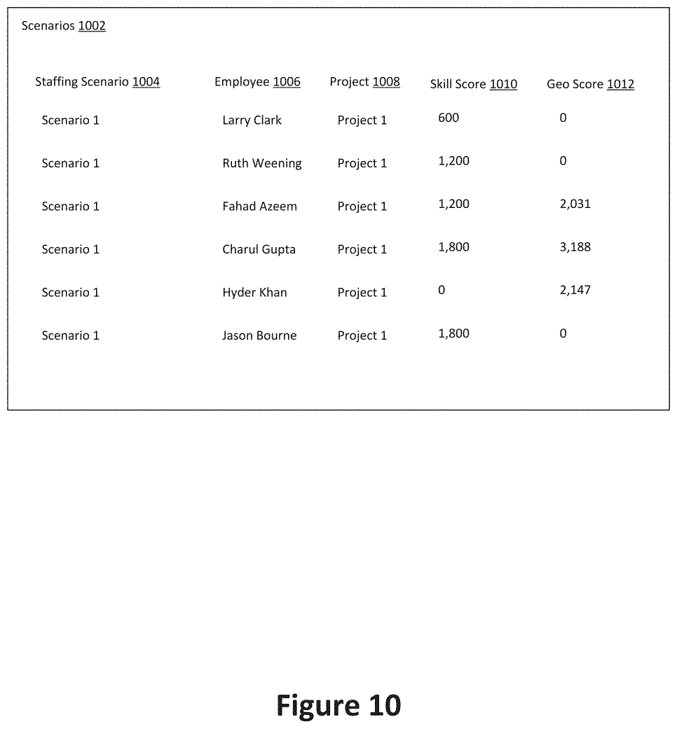

FIG. 10 illustrates scenarios 1002. Scenarios 1002 may include one or more staffing scenarios 1004. Such staffing scenarios may be one or more potential project teams, Employee 1006 may be one or more potential project team members. Project 1008 may indicate the project that the employee and/or staffing scenario is associated with. Each employee may be rated in one or more categories. For example, for scenarios 1002, each employee may be rated on skill score 1010, which is an aggregate score for the complete skill level of the employee based on the needs of the project, and on geographic score 1012, which is an indication of how close the employee is located to the location of the project.

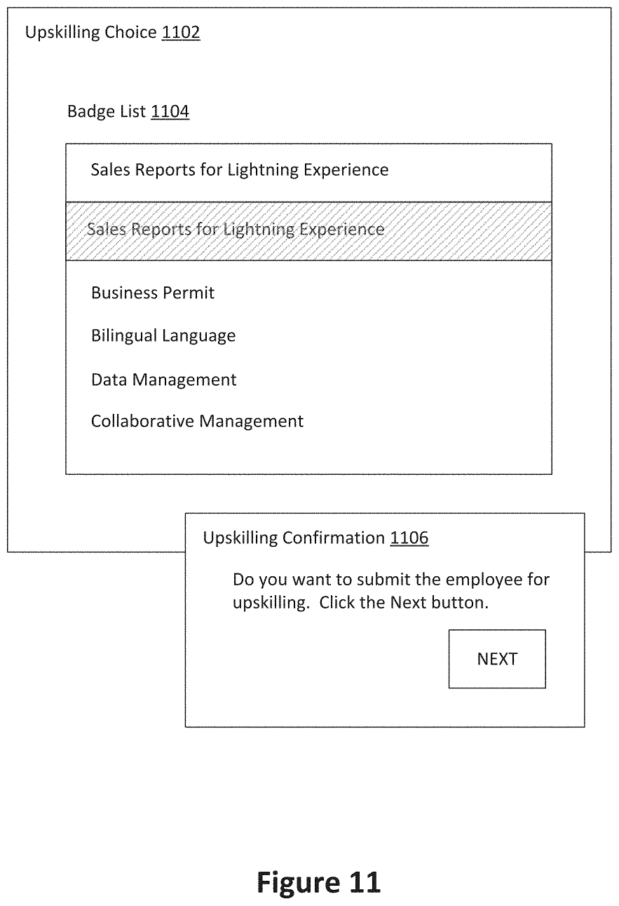

FIG. 11 illustrates an interface for specifying upskilling choice 1102. In upskilling choice 1102, the user may specify a subject for upskilling from badge list 1104. In various embodiments, badge list 1104 may be a list of upskilling recommendations for a potential project team member based on analysis of project data, as described herein. Upon selection of one or more of the subjects within badge list 1104, the interface may then provide upskilling confirmation 1106 for the user to confirm the upskilling. The user may confirm the upskilling, Based on the confirmation, the upskilling may then commence.

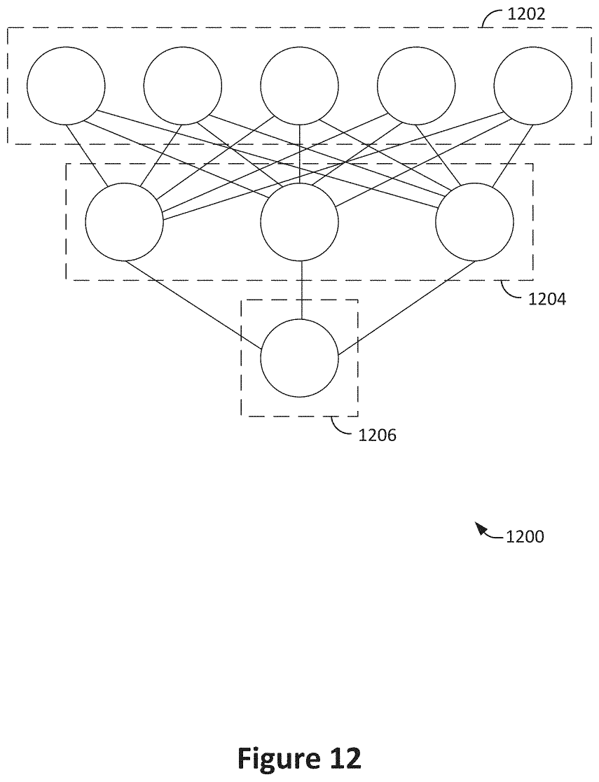

FIG. 12 illustrates an example configuration of a neural network, configured in accordance with one or more embodiments. FIG. 12 illustrates a neural network 1200 that includes input layer 1202, hidden layers 1204, and output layer 1206. Neural network 1200 may be a machine learning network that may be trained to provide recommend project teams in accordance with techniques described herein. In other embodiments, neural network 1200 may be a machine learning network used for determining or modifying distance functions for recommendation of project teams, as described herein.

Neural network 1200 may be trained with inputs that include previous project teams and their performance thereof (e.g., the project manager may rate the performance of the team based upon various metrics and such ratings may form part of the input). Input layer 1202 may include such inputs. Hidden layers 1204 may be one or more intermediate layers where logic is performed to determine the performance of the project team or a distance function based on their rated performance. Output layer 1206 may result from computation performed within hidden layers 1204 and may output the efficiency of a project team's composition based on the input and the rated performance.

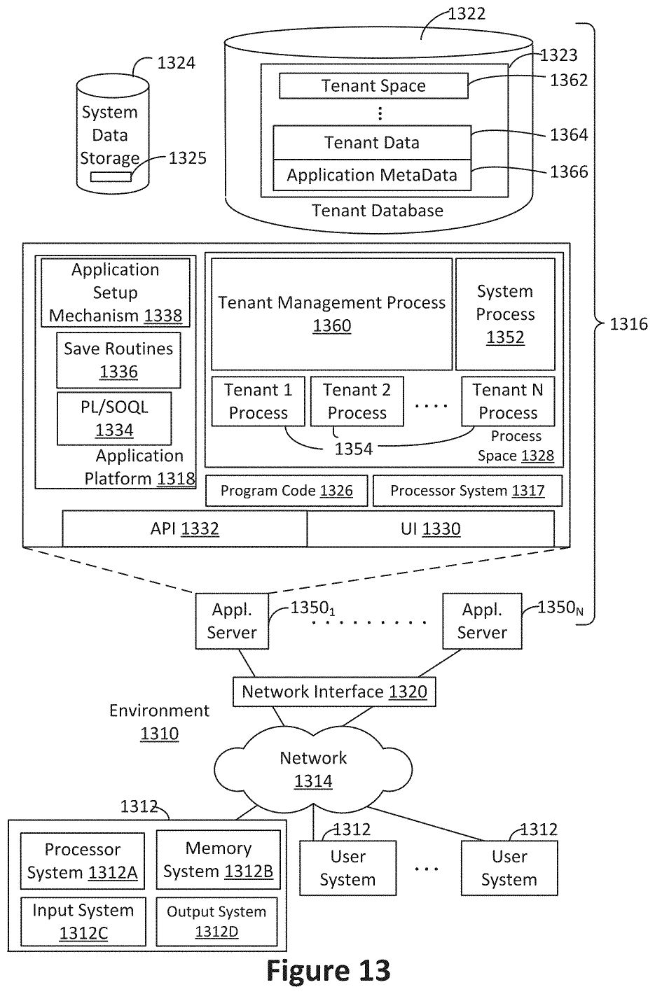

FIG. 13 shows a block diagram of an example of an environment 1310 that includes an on-demand database service configured in accordance with some implementations. Environment 1310 may include user systems 1312, network 1314, database system 1316, processor system 1317, application platform 1318, network interface 1320, tenant data storage 1322, tenant data 1323, system data storage 1324, system data 1325, program code 1326, process space 1328, User Interface (UI) 1330, Application Program Interface (API) 1332, PL/SOQL 1334, save routines 1336, application setup mechanism 1338, application servers 1350-1 through 1350-N, system process space 1352, tenant process spaces 1354, tenant management process space 1360, tenant storage space 1362, user storage 1364, and application metadata 1366. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 1316, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 1318 may be a framework that allows the creation, management, and execution of applications in system 1316. Such applications may be developed by the database service provider or by users or third-party application developers accessing the service. Application platform 1318 includes an application setup mechanism 1338 that supports application developers' creation and management of applications, which may be saved as metadata into tenant data storage 1322 by save routines 1336 for execution by subscribers as one or more tenant process spaces 1354 managed by tenant management process 1360 for example. Invocations to such applications may be coded using PL/SOQL 1334 that provides a programming language style interface extension to API 1332, A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 1366 for a subscriber making such an invocation. Such system processes may also manage execution of application metadata 1366 as an application in a virtual machine.

In some implementations, each application server 1350 may handle requests for any user associated with any organization. A load balancing function (e.g., an F5 Big-IP load balancer) may distribute requests to the application servers 1350 based on an algorithm such as least-connections, round robin, observed response time, etc. Each application server 1350 may be configured to communicate with tenant data storage 1322 and the tenant data 1323 therein, and system data storage 1324 and the system data 1325 therein to serve requests of user systems 1312. The tenant data 1323 may be divided into individual tenant storage spaces 1362, which can be either a physical arrangement and/or a logical arrangement of data, Within each tenant storage space 1362, user storage 1364 and application metadata 1366 may be similarly allocated for each user. For example, a copy of a user's most recently used (MRU) items might be stored to user storage 1364. Similarly, a copy of MRU items for an entire tenant organization may be stored to tenant storage space 1362. A UI 1330 provides a user interface and an API 1332 provides an application programming interface to system 1316 resident processes to users and/or developers at user systems 1312.

System 1316 may implement a web-based project team recommendation system. For example, in some implementations, system 1316 may include application servers configured to implement and execute project team recommendation software applications. The application servers may be configured to provide related data, code, forms, web pages and other information to and from user systems 1312. Additionally, the application servers may be configured to store information to, and retrieve information from a database system. Such information may include related data, objects, and/or Webpage content. With a multi-tenant system, data for multiple tenants may be stored in the same physical database object in tenant data storage 1322, however, tenant data may be arranged in the storage medium(s) of tenant data storage 1322 so that data of one tenant is kept logically separate from that of other tenants. In such a scheme, one tenant may not access another tenant's data, unless such data is expressly shared.

Several elements in the system shown in FIG. 13 include conventional, well-known elements that are explained only briefly here. For example, user system 1312 may include processor system 1312A, memory system 1312B, input system 1312C, and output system 1312D. A user system 1312 may be implemented as any computing device(s) or other data processing apparatus such as a mobile phone, laptop computer, tablet, desktop computer, or network of computing devices. User system 12 may run an Internet browser allowing a user (e.g., a subscriber of an MTS) of user system 1312 to access, process and view information, pages and applications available from system 1316 over network 1314. Network 1314 may be any network or combination of networks of devices that communicate with one another, such as any one or any combination of a LAN (local area network), WAN (wide area network), wireless network, or other appropriate configuration.

The users of user systems 1312 may differ in their respective capacities, and the capacity of a particular user system 1312 to access information may be determined at least in part by “permissions” of the particular user system 1312. As discussed herein, permissions generally govern access to computing resources such as data objects, components, and other entities of a computing system, such as a project team recommendation system, a social networking system, and/or a CRM database system. “Permission sets” generally refer to groups of permissions that may be assigned to users of such a computing environment. For instance, the assignments of users and permission sets may be stored in one or more databases of System 1316. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 1316 may provide on-demand database service to user systems 1312 using an MTS arrangement. By way of example, one tenant organization may be a company that employs a sales force where each salesperson uses system 1316 to manage their sales process. Thus, a user in such an organization may maintain contact data, leads data, customer follow-up data, performance data, goals and progress data, etc., all applicable to that user's personal sales process (e.g., in tenant data storage 1322). In this arrangement, a user may manage his or her sales efforts and cycles from a variety of devices, since relevant data and applications to interact with (e.g., access, view, modify, report, transmit, calculate, etc.) such data may be maintained and accessed by any user system 1312 having network access.

When implemented in an MTS arrangement, system 1316 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 1316 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 1316 may also maintain system-level data usable by multiple tenants or other data. Such system-level data may include industry reports, news, postings, and the like that are sharable between tenant organizations.

In some implementations, user systems 1312 may be client systems communicating with application servers 1350 to request and update system-level and tenant-level data from system 1316. By way of example, user systems 1312 may send one or more queries requesting data of a database maintained in tenant data storage 1322 and/or system data storage 1324. An application server 1350 of system 1316 may automatically generate one or more SQL statements (e.g., one or more SQL queries) that are designed to access the requested data. System data storage 1324 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc, Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

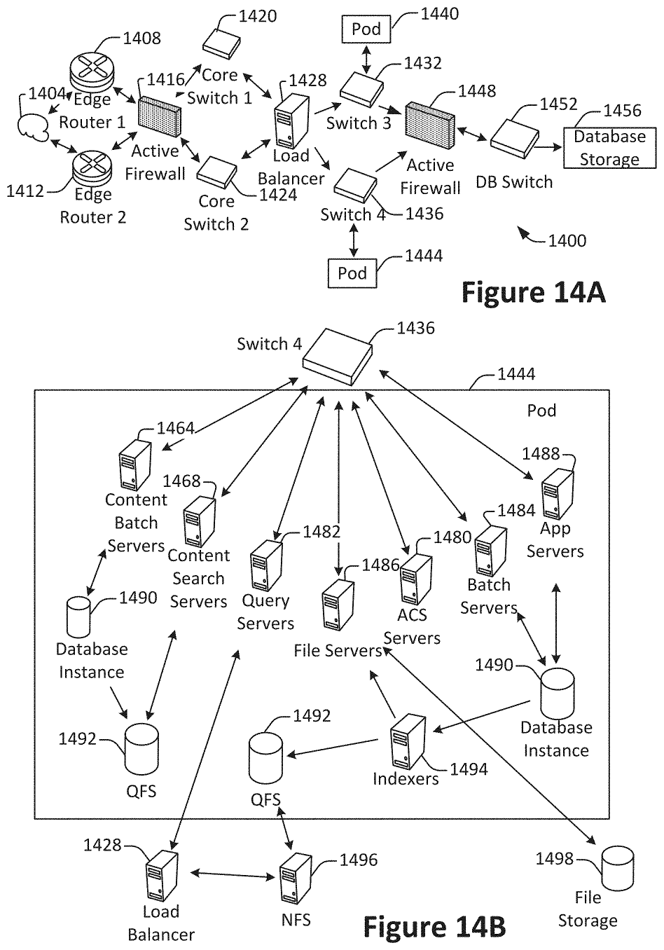

FIG. 14A shows a system diagram of an example of architectural components of an on-demand database service environment 1400, configured in accordance with some implementations. A client machine located in the cloud 1404 may communicate with the on-demand database service environment via one or more edge routers 1408 and 1412. A client machine may include any of the examples of user systems 1312 described above. The edge routers 1408 and 1412 may communicate with one or more core switches 1420 and 1424 via firewall 1416. The core switches may communicate with a load balancer 1428, which may distribute server load over different pods, such as the pods 1440 and 1444 by communication via pod switches 1432 and 1436. The pods 1440 and 1444, which may each include one or more servers and/or other computing resources, may perform data processing and other operations used to provide on-demand services. Components of the environment may communicate with a database storage 1456 via a database firewall 1448 and a database switch 1452.

Accessing an on-demand database service environment may involve communications transmitted among a variety of different components. The environment 1400 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 14A and 14B.

The cloud 1404 refers to any suitable data network or combination of data networks, which may include the Internet. Client machines located in the cloud 1404 may communicate with the on-demand database service environment 1400 to access services provided by the on-demand database service environment 1400. By way of example, client machines may access the on-demand database service environment 1400 to retrieve, store, edit, and/or process project team recommendation information.

In some implementations, the edge routers 1408 and 1412 route packets between the cloud 1404 and other components of the on-demand database service environment 1400. The edge routers 1408 and 1412 may employ the Border Gateway Protocol (BGP). The edge routers 1408 and 1412 may maintain a table of IP networks or ‘prefixes’, which designate network reachability among autonomous systems on the internet.

In one or more implementations, the firewall 1416 may protect the inner components of the environment 1400 from internet traffic. The firewall 1416 may block, permit, or deny access to the inner components of the on-demand database service environment 1400 based upon a set of rules and/or other criteria. The firewall 1416 may act as one or more of a packet filter, an application gateway, a stateful filter, a proxy server, or any other type of firewall.

In some implementations, the core switches 1420 and 1424 may be high-capacity switches that transfer packets within the environment 1400. The core switches 1420 and 1424 may be configured as network bridges that quickly route data between different components within the on-demand database service environment. The use of two or more core switches 1420 and 1424 may provide redundancy and/or reduced latency.

In some implementations, communication between the pods 1440 and 1444 may be conducted via the pod switches 1432 and 1436. The pod switches 1432 and 1436 may facilitate communication between the pods 1440 and 1444 and client machines, for example via core switches 1420 and 1424. Also or alternatively, the pod switches 1432 and 1436 may facilitate communication between the pods 1440 and 1444 and the database storage 1456. The load balancer 1428 may distribute workload between the pods, which may assist in improving the use of resources, increasing throughput, reducing response times, and/or reducing overhead. The load balancer 1428 may include multilayer switches to analyze and forward traffic.

In some implementations, access to the database storage 1456 may be guarded by a database firewall 1448, which may act as a computer application firewall operating at the database application layer of a protocol stack. The database firewall 1448 may protect the database storage 1456 from application attacks such as structure query language (SQL) injection, database rootkits, and unauthorized information disclosure. The database firewall 1448 may include a host using one or more forms of reverse proxy services to proxy traffic before passing it to a gateway router and/or may inspect the contents of database traffic and block certain content or database requests. The database firewall 1448 may work on the SQL application level atop the TCP/IP stack, managing applications' connection to the database or SQL management interfaces as well as intercepting and enforcing packets traveling to or from a database network or application interface.

In some implementations, the database storage 1456 may be an on-demand database system shared by many different organizations. The on-demand database service may employ a single-tenant approach, a multi-tenant approach, a virtualized approach, or any other type of database approach. Communication with the database storage 1456 may be conducted via the database switch 1452. The database storage 1456 may include various software components for handling database queries. Accordingly, the database switch 1452 may direct database queries transmitted by other components of the environment (e.g., the pods 1440 and 1444) to the correct components within the database storage 1456.

FIG. 14B shows a system diagram further illustrating an example of architectural components of an on-demand database service environment, in accordance with some implementations. The pod 1444 may be used to render services to user(s) of the on-demand database service environment 1400. The pod 1444 may include one or more content batch servers 1464, content search servers 1468, query servers 1482, file servers 1486, access control system (ACS) servers 1480, batch servers 1484, and app servers 1488. Also, the pod 1444 may include database instances 1490, quick file systems (QFS) 1492, and indexers 1494. Some or all communication between the servers in the pod 1444 may be transmitted via the switch 1436.

In some implementations, the app servers 1488 may include a framework dedicated to the execution of procedures (e.g., programs, routines, scripts) for supporting the construction of applications provided by the on-demand database service environment 1400 via the pod 1444. One or more instances of the app server 1488 may be configured to execute all or a portion of the operations of the services described herein.

In some implementations, as discussed above, the pod 1444 may include one or more database instances 1490. A database instance 1490 may be configured as an MTS in which different organizations share access to the same database, using the techniques described above. Database information may be transmitted to the indexer 1494, which may provide an index of information available in the database 1490 to file servers 1486. The QFS 1492 or other suitable filesystem may serve as a rapid-access file system for storing and accessing information available within the pod 1444. The QFS 1492 may support volume management capabilities, allowing many disks to be grouped together into a file system. The QFS 1492 may communicate with the database instances 1490, content search servers 1468 and/or indexers 1494 to identify, retrieve, move, and/or update data stored in the network file systems (NFS) 1496 and/or other storage systems.

In some implementations, one or more query servers 1482 may communicate with the NFS 1496 to retrieve and/or update information stored outside of the pod 1444. The NFS 1496 may allow servers located in the pod 1444 to access information over a network in a manner similar to how local storage is accessed. Queries from the query servers 1422 may be transmitted to the NFS 1496 via the load balancer 1428, which may distribute resource requests over various resources available in the on-demand database service environment 1400. The NFS 1496 may also communicate with the QFS 1492 to update the information stored on the NFS 1496 and/or to provide information to the QFS 1492 for use by servers located within the pod 1444.

In some implementations, the content batch servers 1464 may handle requests internal to the pod 1444. These requests may be long-running and/or not tied to a particular customer, such as requests related to log mining, cleanup work, and maintenance tasks. The content search servers 1468 may provide query and indexer functions such as functions allowing users to search through content stored in the on-demand database service environment 1400. The file servers 1486 may manage requests for information stored in the file storage 1498, which may store information such as documents, images, basic large objects (BLOBs), etc. The query servers 1482 may be used to retrieve information from one or more file systems. For example, the query system 1482 may receive requests for information from the app servers 1488 and then transmit information queries to the NFS 1496 located outside the pod 1444. The ACS servers 1480 may control access to data, hardware resources, or software resources called upon to render services provided by the pod 1444. The batch servers 1484 may process batch jobs, which are used to run tasks at specified times. Thus, the batch servers 1484 may transmit instructions to other servers, such as the app servers 1488, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

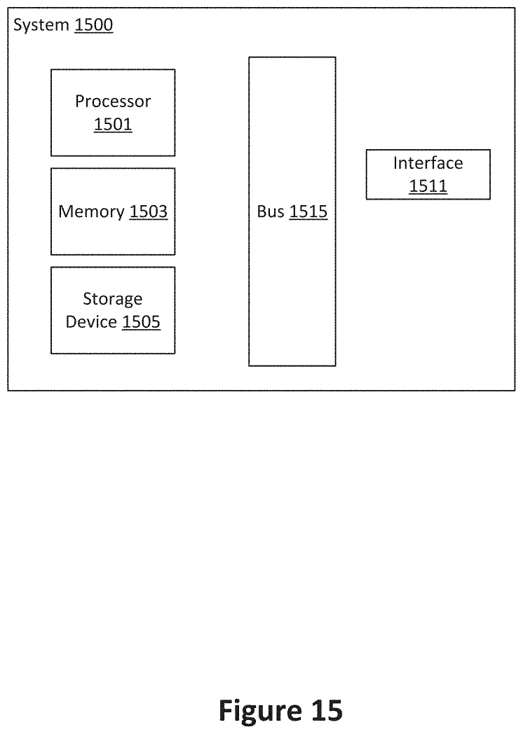

FIG. 15 illustrates one example of a computing device. According to various embodiments, a system 1500 suitable for implementing embodiments described herein includes a processor 1501, a memory module 1503, a storage device 1505, an interface 1511, and a bus 1515 (e.g., a PCI bus or other interconnection fabric.) System 1500 may operate as variety of devices such as an application server, a database server, or any other device or service described herein. Although a particular configuration is described, a variety of alternative configurations are possible. The processor 1501 may perform operations such as those described herein. Instructions for performing such operations may be embodied in the memory 1503, on one or more non-transitory computer readable media, or on some other storage device. Various specially configured devices can also be used in place of or in addition to the processor 1501. The interface 1511 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A computer-implemented method comprising:
receiving, at a server within an on-demand computing services environment, a plurality of project management parameters comprising a first skillset;
accessing project data, stored in a project database stored in a database system, to obtain project ratings for each of a plurality of potential team members, the project ratings comprising at least a first skill rating associated with the first skillset;
determining, via a processor and based on the first skill rating of at least one of the potential team members, an upskilling action for the at least one potential team member;
accessing, based on the determined upskilling action, upskilling data stored in an upskilling database of the database system;
determining, via the processor, an upskilling source associated with the upskilling action from the upskilling data; and
transmitting, by the server via a communications interface through a network, project management data to a client device, the project management data comprising:
the project ratings for the plurality of potential team members;
the upskilling action for the at least one potential team member; and
the upskilling source associated with the upskilling action.

2. The computer-implemented method of claim 1, further comprising:
receiving, at the server, an upskilling order for the at least one potential team member; and
transmitting, by the server, an upskilling request associated with the at least one potential team member based on the receiving the upskilling order.

3. The computer-implemented method of claim 2, wherein the upskilling request is transmitted to a secondary API.

4. The computer-implemented method of claim 2, wherein the upskilling request is transmitted to an upskilling provider.

5. The computer-implemented method of claim 2, further comprising:
transmitting, by the server via the communications interface through the network, an upskilling test based on previously transmitting the upskilling request.

6. The computer-implemented method of claim 1, wherein the project ratings further comprise at least a second skill rating associated with a geographic location of the potential team members, and wherein the method further comprises:
determining, via the processor and based on the geographic location of the potential team members, a geographic rating for each of the potential team members, wherein the project management data further comprises the second skill rating.

7. The computer-implemented method of claim 6, further comprising:
determining, via the processor and based on at least the first skill rating and the second skill rating, a suitability rating for the at least one potential team member, wherein the transmitting the project management data further comprises transmitting the suitability rating.

8. The computer-implemented method of claim 7, wherein the suitability rating is determined by processing a distance function with the first skill rating and the second skill rating as inputs.

9. The computer-implemented method of claim 1, further comprising:
determining, via the processor and based on the project management parameters, a selection of one or more of the plurality of potential team members.

10. The computer-implemented method of claim 1, further comprising:
determining, via the processor and based on the first skill rating of a first potential team member, that the first skill rating of the first potential team member is below a threshold rating; and
excluding, via the processor, data associated with the first potential team member from the project management data.

11. A system comprising:
a communications interface;
a database system;
a processor; and
a non-transitory memory comprising instructions stored thereon to cause the processor to perform operations comprising:
receiving, within an on-demand computing services environment, a plurality of project management parameters comprising a first skillset;
accessing project data, stored in a project database of the database system, to obtain project ratings for each of a plurality of potential team members, the project ratings comprising at least a first skill rating associated with the first skillset;
determining, via the processor and based on the first skill rating of at least one of the potential team members, an upskilling action for the at least one potential team member;
accessing, based on the determined upskilling action, upskilling data stored in an upskilling database of the database system;
determining, via the processor, an upskilling source associated with the upskilling action from the upskilling data; and
transmitting, via the communications interface through a network, project management data to a client device, the project management data comprising:
the project ratings for the plurality of potential team members;
the upskilling action for the at least one potential team member; and
the upskilling source associated with the upskilling action.

12. The system of claim 11, wherein the operations further comprise:
receiving an upskilling order for the at least one potential team member; and
transmitting an upskilling request associated with the at least one potential team member based on the receiving the upskilling order.

13. The system of claim 12, wherein the upskilling request is transmitted to a secondary API and/or an upskilling provider.

14. The system of claim 12, wherein the operations further comprise:
transmitting, via the communications interface through the network, an upskilling test based on previously transmitting the upskilling request.

15. The system of claim 11, wherein the project ratings further comprise at least a second skill rating associated with a geographic location of the potential team members, and wherein the operations further comprise:
determining, via the processor and based on the geographic location of the potential team members, a geographic rating for each of the potential team members, wherein the project management data further comprises the second skill rating.

16. The system of claim 15, wherein the operations further comprise:
determining, via the processor and based on at least the first skill rating and the second skill rating, a suitability rating for the at least one potential team member, wherein the transmitting the project management data further comprises transmitting the suitability rating, wherein the suitability rating is determined by processing a distance function with the first skill rating and the second skill rating as inputs.

17. The system of claim 11, wherein the operations further comprise:
determining, via the processor and based on the project management parameters, a selection of one or more of the plurality of potential team members.

18. The system of claim 11, wherein the operations further comprise:
determining, via the processor and based on the first skill rating of a first potential team member, that the first skill rating of the first potential team member is below a threshold rating; and
excluding, via the processor, data associated with the first potential team member from the project management data.

19. A computer program product comprising computer-readable program code capable of being executed by one or more processors in a customer dashboard segmentation environment when retrieved from a non-transitory computer-readable medium, the program code comprising instructions configurable to cause operations comprising:
receiving, at a server within an on-demand computing services environment, a plurality of project management parameters comprising a first skillset;
accessing project data, stored in a project database stored in a database system, to obtain project ratings for each of a plurality of potential team members, the project ratings comprising at least a first skill rating associated with the first skillset;
determining, via a processor and based on the first skill rating of at least one of the potential team members, an upskilling action for the at least one potential team member;
accessing, based on the determined upskilling action, upskilling data stored in an upskilling database of the database system;
determining, via the processor, an upskilling source associated with the upskilling action from the upskilling data; and
transmitting, by the server via a communications interface through a network, project management data to a client device, the project management data comprising:
the project ratings for the plurality of potential team members;
the upskilling action for the at least one potential team member; and
the upskilling source associated with the upskilling action.

20. The computer program product of claim 19, wherein the operations further comprise:
receiving an upskilling order for the at least one potential team member; and
transmitting an upskilling request associated with the at least one potential team member based on the receiving the upskilling order.
